(19) United States
(12) Patent Application Publication
(10) Pub. No.: US 2026/0156022 A1
(43) Pub. Date: Jun. 4, 2026

(54) METHODS FOR ENABLING OVER-THE-AIR FEDERATED LEARNING USING UPLINK PRE-EQUALIZATION

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); John Kaewell, Jamison, PA (US)

(73) Assignee: InterDigital Patent Holdings, Inc., Wilmington, DE (US)

(21) Appl. No.: 18/965,536

(22) Filed: Dec. 2, 2024

(51) Int. Cl. H04L 25/03; G06N 20/00; H04L 5/00; H04L 25/02

(52) U.S. Cl. CPC H04L 25/03343; G06N 20/00; H04L 5/0048; H04L 25/0202

(57) ABSTRACT

A method implemented by a wireless transmit/receive unit (WTRU) may include receiving configuration information for over-the-air federated learning (OTA-FL) training rounds of an Artificial Intelligence/Machine Learning (AI/ML) model residing at the WTRU, which may include allocations of over-the-air reference signal (OTA-RS) resources and mechanisms for the uplink pre-equalization. An indication of uplink resource allocations for transmitting pre-equalized locally updated AI/ML model parameters may be received during the OTA-FL training rounds. A trained AI/ML model may be determined by local AI/ML model training. Local AI/ML model parameters or gradients may be generated for an FL task. Channel estimation may be performed during training rounds. Uplink pre-equalization parameters may be determined based on the channel estimation. Locally updated AI/ML model parameters may be pre-equalized for transmission. Pre-equalized locally updated AI/ML model parameters may be sent over uplink resources allocated during the OTA-FL training rounds. An updated global AI/ML model may be received.

### BACKGROUND

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (e.g., data), without being explicitly programmed (e.g., configuring a set of rules). ML can be considered as a subset of AI. Different ML paradigms may be envisioned based on the nature of data or feedback available to the learning algorithm. In a first example, a supervised learning approach may involve learning a function that maps input to an output based on labeled training example, wherein each training example may be a pair consisting of an input and its corresponding output. In a second example, an unsupervised learning approach may involve detecting patterns in the data with no pre-existing labels. In a third example, a reinforcement learning approach may involve performing sequence of actions in an environment to maximize the cumulative reward. In some solutions, it is possible to apply ML algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (e.g., with no labeled training data) and supervised learning (e.g., with only labeled training data).

Deep learning may refer to a class of ML algorithms that employ artificial neural networks (e.g., Deep Neural Networks (DNNs)), which were loosely inspired from biological systems. The DNNs are a special class of ML models that are inspired by the human brain wherein the input may be linearly transformed and may pass through non-linear activation function multiple times. DNNs consist typically of multiple layers where each layer consists of linear transformation and a given non-linear activation function. The DNNs can be trained using the training data via back-propagation algorithm. Recently, DNNs have shown state-of-the-art performance in a variety of domains, e.g., speech, vision, natural language, wireless communication, etc., and for various ML settings (supervised, un-supervised, and/or semi-supervised).

### SUMMARY

A wireless receive/transmit unit (WTRU) may comprise a processor configured to receive configuration information from a network for participating in one or more over-the-air federated learning (OTA-FL) training rounds of an AI/ML model residing at the WTRU. The configuration information may include an allocation of over-the-air reference signal (OTA-RS) resources and a mechanism to perform the uplink pre-equalization. An indication of uplink resource allocations for transmitting pre-equalized locally updated AI/ML model parameters may be received during the OTA-FL training rounds. A trained AI/ML model may be determined by performing local AI/ML model training. One or more of local AI/ML model parameters or gradients may be generated for an FL task. Channel estimation may be performed during training rounds using OTA-RSs received via the OTA-RS resources. Uplink pre-equalization parameters may be determined based on the channel estimation. Locally updated AI/ML model parameters may be pre-equalized for transmission on resource elements based on the uplink resource allocations and the pre-equalization parameters. The pre-equalized locally updated AI/ML model parameters may be sent over the uplink resources allocated according to the configuration information during the OTA-FL training rounds. An updated global AI/ML model may be received.

The configuration information may include mapping instructions that associate the pre-equalized locally updated AI/ML model parameters with uplink resource elements during the OTA-FL training rounds. The processor is configured to receive a configuration indicating how one or more of the locally updated AI/ML model parameters, gradients, or AI/ML parameter incremental updates are mapped to the uplink resources, or to receive a configuration indicating how the pre-equalized locally updated AI/ML model parameters are mapped as real and imaginary components of complex symbols for uplink transmission during the OTA-FL training rounds.

The processor may be configured to transmit incremental updates to the AI/ML model parameters during the OTA-FL training rounds, the incremental updates representing differences between the locally updated AI/ML model parameters and parameters of a reference AI/ML model.

The processor may be configured to perform channel estimation using the OTA-RSs, wherein the OTA-RSs comprise pilot sequences configured to provide a density higher than Channel State Information Reference Signals (CSI-RSs) in a frequency domain based on delay spread and a density higher than the CSI-RSs in a time domain based on a speed of the WTRU.

The processor may be configured to receive calibration information from the network during the training rounds, wherein the calibration information indicates parameters to adjust uplink phase and amplitude errors associated with one or more resource elements (REs) during the OTA-FL training rounds.

The processor may be configured to receive a calibration message from the network, wherein the calibration message indicates one or more WTRUs determined to be qualified for uplink transmission during the OTA-FL training rounds.

The uplink resources may be allocated to a plurality of WTRUs performing a same OTA-FL task to transmit pre-equalized locally updated AI/ML model parameters to the network.

The processor may be configured to receive the indication of uplink resources for OTA-FL model parameter exchange dynamically via uplink scheduling grants with a group Radio Network Temporary Identifier (RNTI), wherein the group RNTI is common for the plurality of WTRUs performing the same OTA-FL task.

The uplink resources may be dynamically allocated by at least one of downlink control information (DCI) or physical downlink control channel (PDCCH) transmission. The mechanism to perform the uplink pre-equalization may include one or more of phase correction, channel inversion, or truncated channel inversion.

The processor may be configured to refine the updated global AI/ML model received by the WTRU through multiple OTA-FL training rounds coordinated by the network.

Methods implemented by a wireless transmit/receive unit (WTRU) may be described herein. The method may include receiving configuration information from a network for participating in one or more over-the-air federated learning (OTA-FL) training rounds of an Artificial Intelligence/Machine Learning (AI/ML) model residing at the WTRU. The configuration information may include an allocation of over-the-air reference signal (OTA-RS) resources and a mechanism to perform the uplink pre-equalization. An indication of uplink resource allocations for transmitting pre-equalized locally updated AI/ML model parameters may be received during the OTA-FL training rounds. A trained AI/ML model may be determined by performing local AI/ML model training. One or more of local AI/ML model parameters or gradients may be generated for an FL task. Channel estimation may be performed during training rounds using OTA-RSs received via the OTA-RS resources. Uplink pre-equalization parameters may be determined based on the channel estimation. Locally updated AI/ML model parameters may be pre-equalized for transmission on resource elements based on the uplink resource allocations and the pre-equalization parameters. The pre-equalized locally updated AI/ML model parameters may be sent over the uplink resources allocated according to the configuration information during the OTA-FL training rounds. An updated global AI/ML model may be received.

The configuration information may include configuration information comprises mapping instructions that associate the pre-equalized locally updated AI/ML model parameters with uplink resource elements during the OTA-FL training rounds. The method may include receiving a configuration indicating how one or more of the locally updated AI/ML model parameters, gradients, or AI/ML parameter incremental updates are mapped to the uplink resources, or receiving a configuration indicating how the pre-equalized locally updated AI/ML model parameters are mapped as real and imaginary components of complex symbols for uplink transmission during the OTA-FL training rounds.

The method may include transmitting incremental updates to the AI/ML model parameters during the OTA-FL training rounds, the incremental updates representing differences between the locally updated AI/ML model parameters and parameters of a reference AI/ML model.

The method may include performing channel estimation using the OTA-RSs, wherein the OTA-RSs comprise pilot sequences configured to provide a density higher than Channel State Information Reference Signals (CSI-RSs) in a frequency domain based on delay spread and a density higher than the CSI-RSs in a time domain based on a speed of the WTRU.

The method may include receiving calibration information from the network during the training rounds, wherein the calibration information indicates parameters to adjust uplink phase and amplitude errors associated with one or more resource elements (REs) during the OTA-FL training rounds.

The method may include receiving a calibration message from the network, wherein the calibration message indicates one or more WTRUs determined to be qualified for uplink transmission during the OTA-FL training rounds.

The uplink resources may be allocated to a plurality of WTRUs performing a same OTA-FL task to transmit the pre-equalized locally updated AI/ML model parameters to the network.

The method may include receiving the indication of uplink resources for OTA-FL model parameter exchange dynamically via uplink scheduling grants with a group Radio Network Temporary Identifier (RNTI), wherein the group RNTI is common for the plurality of WTRUs performing the same OTA-FL task.

The uplink resources may be dynamically allocated by at least one of downlink control information (DCI) or physical downlink control channel (PDCCH) transmission. The mechanism to perform the uplink pre-equalization may include one or more of phase correction, channel inversion, or truncated channel inversion.

The method may include refining the updated global AI/ML model received by the WTRU through multiple OTA-FL training rounds coordinated by the network.

Over-the-air (OTA) federated learning (FL) may introduce new challenges in addition to those associated with conventional FL. The analog OTA signal aggregation over wireless channels may be subject to distortions caused by channel fading, path loss, radio impairment, and receiver noise, which may negatively affect the quality of OTA aggregation. While wireless transmit/receive units (WTRUs) may perform pre-equalization before transmitting artificial intelligence/machine learning (AI/ML) model parameters in the uplink channel, factors such as imperfect uplink channel estimation, channel aging, and uplink/downlink (UL/DL) calibration errors may degrade the quality of aggregated AI/ML model parameters. Thus, there may be a need for mechanisms to enable OTA-FL transmissions through uplink pre-equalization and to configure one or more WTRUs to participate in OTA-FL training rounds.

In examples, when a WTRU is configured to pre-equalize the transmission of locally updated (e.g., trained) AI/ML model parameters, the pre-equalization may mitigate the effects of wireless channels. The performance of pre-equalization may depend on the accuracy of uplink channel estimation. A proposed enhancement includes the use of a new downlink reference signal, referred to as an over-the-air reference signal (OTA-RS), to improve channel estimation accuracy in OTA-FL. The proposed approach further describes procedures for configuring one or more WTRUs to participate in OTA-FL training rounds, including configurations for OTA-RS allocation and reception, as well as methods for mapping the locally updated AI/ML model parameters to uplink resources. These configurations and procedures may enable OTA-FL through uplink pre-equalization, facilitating coherent reception of AI/ML model parameters during aggregation.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a high-level interaction between participants (e.g., WTRUs) and a central AI server over a 5G system.

FIG. 3 is a diagram illustrating an example Federated Learning (FL) protocol over wireless communication systems.

FIG. 4 depicts an example illustration of the (e.g., conventional) FL and/or over-the-air (OTA)-FL in wireless communication systems.

FIG. 5 is a diagram illustrating procedures for OTA-FL in wireless communication systems.

FIG. 6 is a diagram illustrating an example of mapping locally updated second AI/ML model parameters to uplink resources during over-the-air federated learning (OTA-FL) transmissions.

FIG. 7 is a diagram illustrating an example of resource allocation (e.g., downlink resource allocation) for OTA-RS and CSI-RS with 1 port.

FIG. 8 is a diagram illustrating an example of resource allocation grids when a downlink slot is followed by an uplink slot.

FIG. 9 is a diagram illustrating an example of resource allocation when the downlink and/or the uplink are scheduled in the same slot.

FIG. 10 is a diagram illustrating an example of resource allocation for OTA-RS with 1 port.

FIG. 11 is a diagram illustrating an example of resource allocation for OTA-RS, DMRS and data with 1 port.

FIG. 12 is a diagram illustrating an example of resource allocation for OTA-RS and CSI-RS with 4 ports.

FIG. 13 is a diagram illustrating showing an example of resource allocation for OTA-RS, CSI-RS, and data with 4 ports.

FIG. 14 is a diagram illustrating an example method including WTRU procedures for enabling OTA-FL transmissions using uplink pre-equalization.

FIG. 15 is a diagram illustrating an example of average path loss for each WTRU cluster.

FIG. 16 is a diagram illustrating an example of an OFDM resource grid during OTA-FL training rounds.

FIG. 17 is a diagram illustrating an example of a ResNet model for AI/ML-based channel estimator.

FIG. 18 is a diagram illustrating showing an example of a channel estimation normalized mean square error (NMSE) on a global test dataset during OTA-FL training rounds.

FIG. 19 is a diagram illustrating an example of a channel estimation NMSE on global test dataset per WTRU cluster.

### DETAILED DESCRIPTION

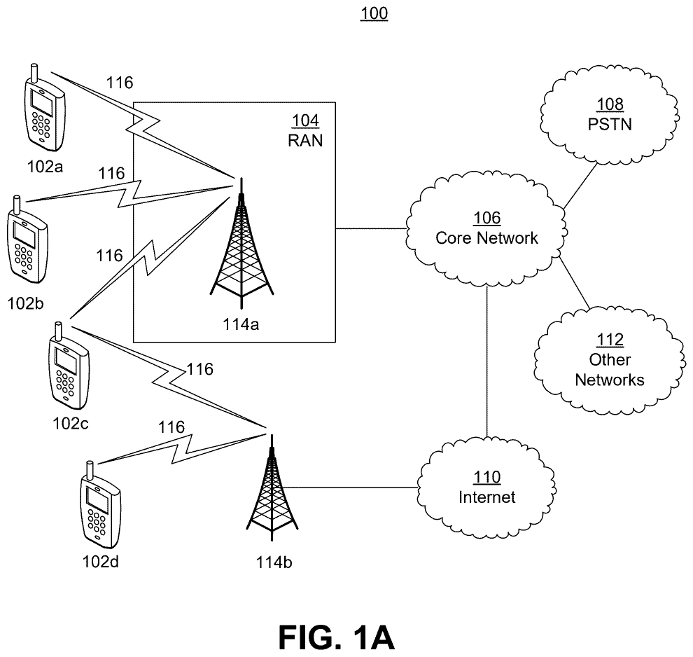

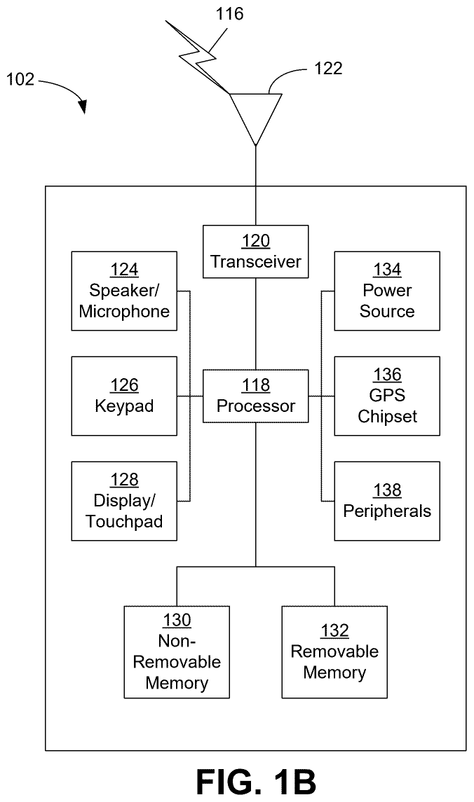

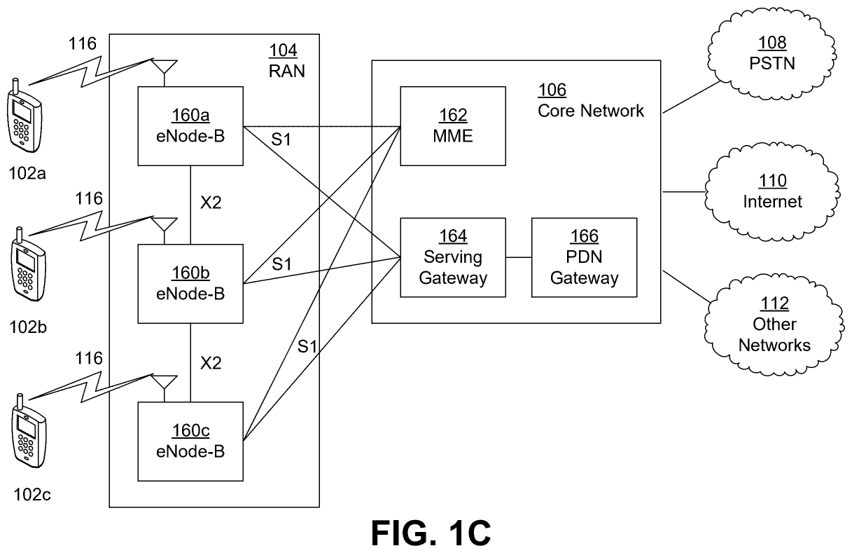

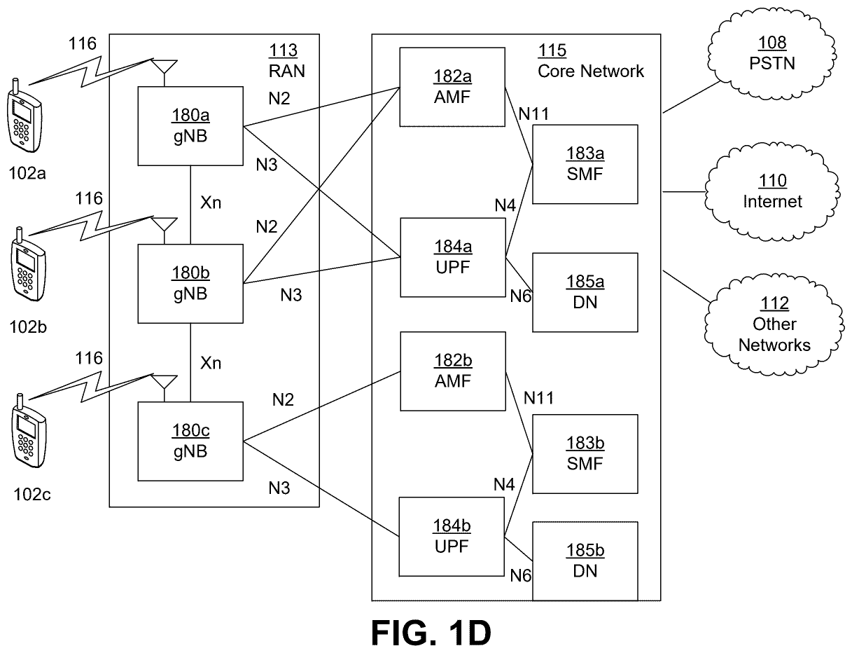

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

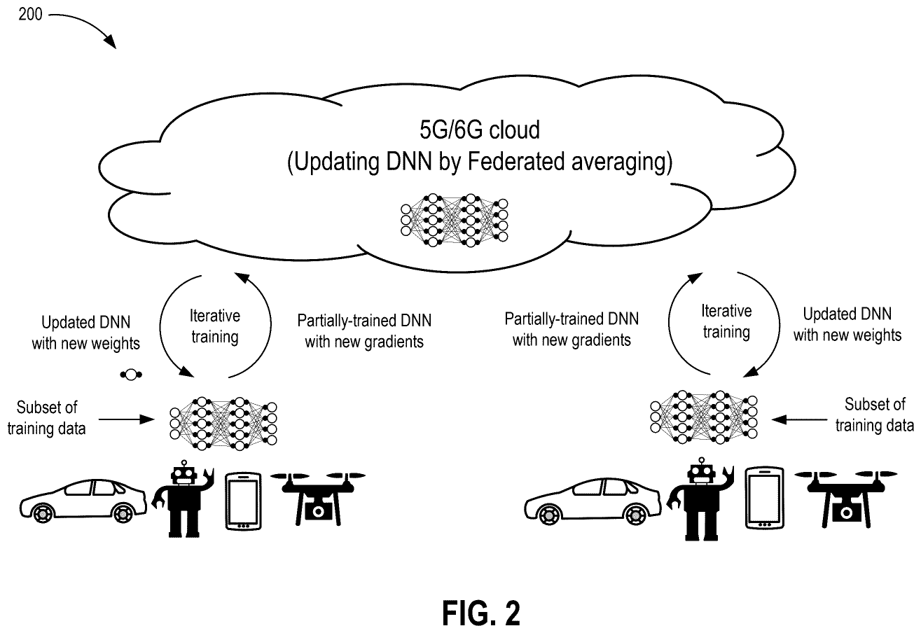

Referring now to FIG. 2, a diagram 200 illustrating a high-level example of Federated Learning (FL) over a 5G system is depicted. The applications of Artificial Intelligence and Machine Learning (AI/ML) in wireless communications may improve the performance of communication systems, and wireless communications may also be utilized to improve the AI/ML model performance.

Federated learning (FL), as a distributed machine learning technique, may improve the AI/ML model performance towards a better model generalization through collaborative learning, while preserving the data privacy and eliminating the large overhead associated with dataset sharing. In FL, the central AI server may obtain a global model by combining (e.g., aggregating) local models trained by each participant (e.g. WTRU) based on a model averaging technique. Therefore, unlike conventional centralized learning, FL may preserve data privacy by removing the need for dataset transfers from the participants (e.g., WTRUs) to the central AI server (e.g., network (NW)) during the AI/ML model training. Furthermore, FL may significantly reduce communication overhead by eliminating the large dataset transfers. AI/ML models trained through FL may achieve better model generalization as compared to the locally trained AI/ML models since FL may enable AI/ML models to learn from datasets from various conditions and distributions.

The WTRU may perform its local model training within each training cycle based on a model downloaded from the centralized AI server using local data. Once the local model training is completed, the WTRU may deliver the training results (e.g., gradient updates for a Deep Neural Network (DNN)) to the centralized AI server via uplink (UL) channels. The centralized AI server may then aggregate the gradients (e.g., model parameters) from the WTRUs and may update the global model. Then, the next training cycle may begin, during which the AI server may distribute the updated global model to WTRUs through downlink (DL) channels.

Referring now to FIG. 2, a diagram 200 showing an example of a high-level interaction between participants (e.g., WTRUs) and a central AI server over a5G system is illustratively depicted. The FL training process over wireless communication systems may differ from FL training conducted in data centers, in which participants (e.g., WTRUs) may experience highly variable conditions in terms of available computational and network resources. Additionally, and/or alternatively, the WTRUs may not be homogeneous, and therefore may have different capabilities in terms of their computing resources, network related resources, and/or which ML frameworks they support. Thus, it may not be efficient for a centralized AI server to include all the WTRUs (e.g., participants) in a training session. Thus, a member selection mechanism may be utilized prior to the commencement of each training cycle. In some examples, if the conditions (e.g., device's computation resource and/or wireless channel condition) have not changed, the WTRU re-selection and/or training re-configurations may not be necessary for each training cycle. However, it may be particularly useful to re-select different WTRUs over time to achieve global training with diverse datasets.

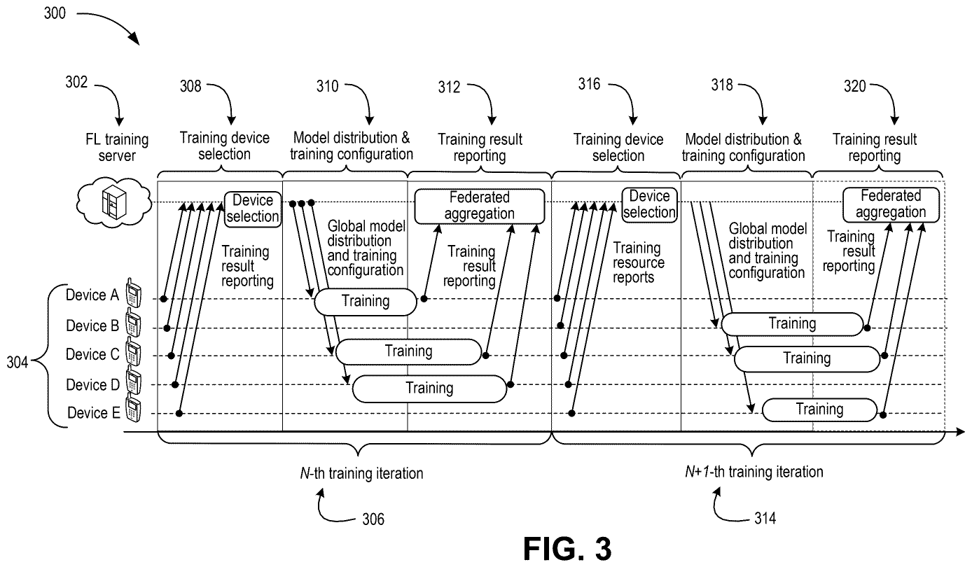

Referring now to FIG. 3, a diagram 300 showing an example Federated Learning (FL) protocol over wireless communication systems is illustratively depicted. The example shown in FIG. 3 may include an FL scenario where a set of participants, such as a set of Devices A-E (e.g., WTRUs 304), may be involved in a distributed training session. However, not all end devices (i.e., WTRUs) may be involved in each training cycle. In some training cycles, some WTRUs may be inactive, while in other sessions, they may be active (e.g., training a local model). For example, Device A may be initially (e.g., during the Nth cycle 306) engaged in a training session, but after it reports its training resources, a centralized FL server (e.g., FL training server 302) may not select Device A for the next cycle (e.g., the (N+1)th cycle 314). Instead, Device B, which was inactive during the Nth cycle, may be selected. There may be instances in which the WTRUs 304 and/or the FL server 302 may be inactive between and/or during the training sessions.

As depicted in FIG. 3, each FL training cycle 306, 314 may be categorized into three operating stages. In a first operating stage 302, the FL training server 302 may select a set of training Devices A-E (e.g., WTRUs 304). During this stage, the training devices (e.g., WTRUs 304) may initially transmit information regarding their training resources to the FL training server 302. Once the FL training server 302 receives all needed information from the training devices (e.g., WTRUs 304), the FL training server 302 may select one or more of the training devices (e.g., WTRUs 304) for participation and/or enter into a next operating stage.

The second operating stage 310 may include model distribution and training configuration, in which the FL training server 302 may distribute a global trained model and associated configurations to one or more selected WTRUs 304. Upon receiving the new model and associated configurations, the WTRUs may initiate local model training at potentially different points in time. After the WTRUs complete the local model training process, the trained models may be delivered to the FL training server, and the next operating stage may begin.

In the third operating stage 312, the FL training server 302 may aggregate the training results received from the WTRUs 304 to generate a global model. Training result reporting may be performed in the third operating stage 312. In examples, following the completion of this aggregation and/or training result reporting in block 312, the training workflow may be repeated (e.g., the (N+1)th cycle 314) in additional training iterations.

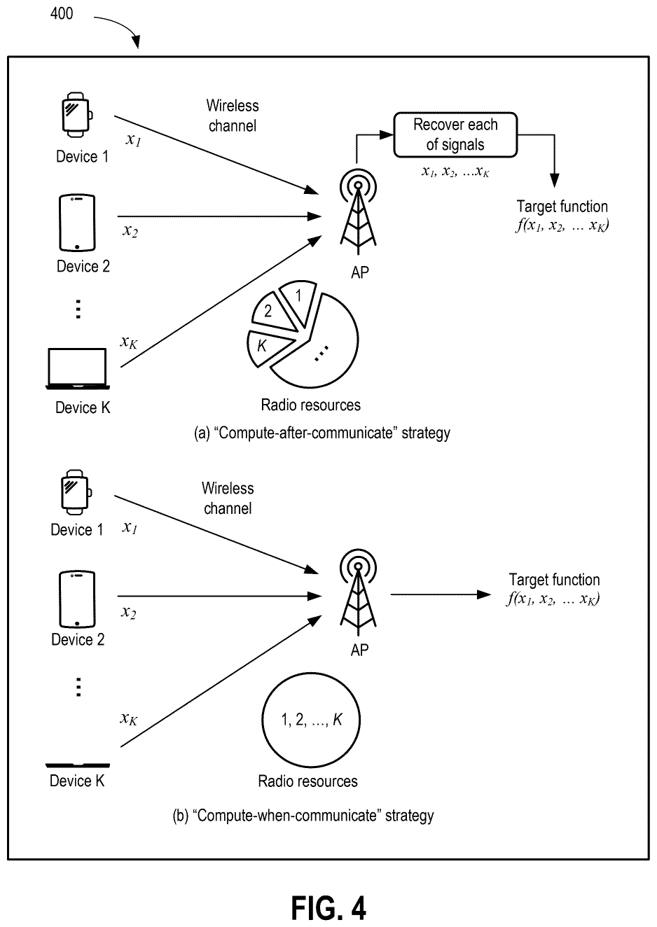

FIG. 4 depicts an example illustration of the (e.g., conventional) FL and/or over-the-air (OTA)-FL in wireless communication systems 400. FL may require a dedicated channel for each participating WTRU, as shown in FIG. 4. End-to-end latency may scale with the number of devices. Over-the-air federated learning (OTA-FL) may enhance the benefit(s) of FL by reducing the end-to-end latency and/or communication overhead through analog aggregation over-the-air. As shown in FIG. 3, each participating WTRU may transmit its locally updated (e.g., trained) AI/ML model parameters (and/or gradients) over interfering radio resources (e.g., channels) during the OTA-FL training rounds. The locally updated AI/ML model parameter(s) may be aggregated and/or combined over-the-air. The NW may receive the aggregated AI/ML model parameters (and/or gradients).

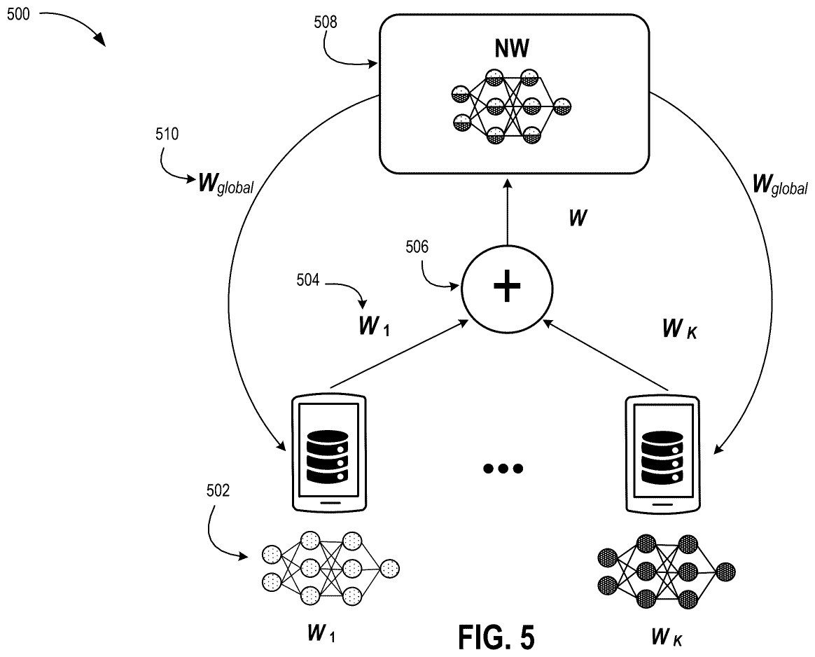

FIG. 5 depicts an example illustration of the procedures for OTA-FL in wireless communication systems 500. FIG. 5 depicts one or more (e.g., five) procedures for OTA-FL in wireless communication systems.

A first procedure (e.g., at 502) for OTA-FL in wireless communication systems may include local training. For example, the WTRU may perform the local AI/ML training through its own dataset.

A second procedure (e.g., at 504) for OTA-FL in wireless communication systems may include pre-processing. The WTRU may perform (e.g., some) pre-processing to the locally updated (e.g., trained) AI/ML model parameter(s) before transmitting them (e.g., computing the gradients, calculating the difference between the locally updated AI/ML model parameter(s) and the received global AI/ML model parameter(s) in the previous OTA-FL training round, etc.).

A third procedure (e.g., at 506) for OTA-FL in wireless communication systems may include OTA aggregation. The WTRU may transmit the locally updated AI/ML model parameter(s) (and/or gradient), where one or more (e.g., all) participating WTRUs may use the same radio resources (e.g., physical channel). The NW may receive the aggregated AI/ML model parameter(s) (and/or gradients). For example, at the example, at the t^{th} OTA-FL training round, the received signal at the NW can be written as follows:

$${y}^{( t )} = {\sum }_{k = 1}^{K} {h}_{k}^{( t )} {w}_{k}^{( t )} + {n}^{( t )} , \qquad ( Equation 1 )$$

where K may be the total number of WTRUs participating in the OTA-FL training rounds,

$${h}_{k}^{( t )}$$

may be the channel between the NW and the k^{th} WTRU (e.g., with single-antenna at the NW and each WTRU) during the t^{th} OTA-FL training round,

$${w}_{k}^{( t )}$$

may be the (e.g., pre-processed) locally updated AI/ML model parameters (and/or gradient) at the k^{th} WTRU, and n^{(t)} may be the receiver noise at the NW in the t^{th} OTA-FL training round. The term y^{(t)} may represent the OTA aggregated AI/ML model parameters (and/or gradient).

A fourth procedure (e.g., at 508) for OTA-FL in wireless communication systems may include post-processing. The NW may apply (e.g., some) post-processing to obtain a (e.g., new) global AI/ML model. In examples, the post-processing may include developing another (e.g., new) global AI/ML model using the received aggregated gradients and/or the global AI/ML model from the previous OTA-FL training round. In example, the post-processing may be performed through a function φ(.) as:

$${\tilde{y}}^{( t )} = φ ( {y}^{( t )} ) \approx {\sum }_{k = 1}^{K} {w}_{k}^{( t )} . \qquad ( Equation 2 )$$

A fifth procedure (e.g., at 510) for OTA-FL in wireless communication systems may include a global model delivery. The NW may distribute the updated global AI/ML model to one or more WTRUs.

Over-the-air (OTA) federated learning (FL) may bring new challenges, in addition to challenges inherited from conventional FL. The analog OTA signal aggregation in wireless channels may be subject to distortions caused by channel fading, path loss, radio impairment, and/or receiver noise, which may negatively affect the OTA aggregation quality. For example, when a first WTRU transmits locally updated AI/ML model parameters (e.g., w₁) to the NW, the parameters may be multiplied with a composite complex channel (e.g., h₁), and then may be aggregated (e.g., summed) with the AI/ML model parameters from other WTRUs (e.g., wk for k=2, . . . , K) multiplied with their own distinct composite complex channel (e.g., hₖ). Thus, the received signal at the NW

$$( e . g . , y = {\sum }_{k = 1}^{K} {h}_{k} {w}_{k} + n )$$

may include, for example, the distorted aggregation of the AI/ML model parameters due to the composite channels along with the noise experienced at the NW's receiver. Although the WTRUs may perform pre-equalization before transmitting the AI/ML model parameters in the uplink channel, imperfect uplink channel estimation, channel aging, and/or UL/DL calibration errors may deteriorate the quality of aggregated AI/ML model parameters (e.g., the performance of the global AI/ML model obtained at the NW). Hence, a mechanism may be utilized for enabling OTA-FL transmissions through uplink pre-equalization and/or configuring one or more WTRUs to participate in OTA-FL training rounds.

In OTA-FL, each participating WTRU may locally train an AI/ML model for a same, or similar, function. When a WTRU is configured to pre-equalize the transmission of locally updated (e.g., locally trained) AI/ML model parameters, the pre-equalization may be utilized to mitigate the effect of wireless channels. For example, by using Equation (1), the received OTA aggregated signal at the NW may be written as follows:

$${y}^{( t )} = {\sum }_{k = 1}^{K} {h}_{k}^{( t )} {p}_{k}^{( t )} {w}_{k}^{( t )} + {n}^{( t )} \approx {\sum }_{k = 1}^{K} {w}_{k}^{( t )} , \qquad ( Equation 3 )$$

where K is the total number of WTRUs participating in the OTA-FL training rounds,

$${h}_{k}^{( t )}$$

is the uplink channel between the NW and the k^{th} WTRU (with the assumption of single-antenna at the NW and each WTRU),

$${p}_{k}^{( t )}$$

is the is the pre-equalization scalar at the k^{th} WTRU,

$${w}_{k}^{( t )}$$

is the locally updated AI/ML model parameters at the k^{th} WTRU, and n(t) is the receiver noise at the NW. Thus, the pre-equalization may target mitigating the effect of wireless channels accordingly. In examples, the pre-equalization performance may depend at least in part on uplink channel estimation accuracy.

A new downlink reference signal (e.g., OTA-RS) may be utilized to improve channel estimation accuracy for resource elements (REs) used in OTA-FL. The new OTA-RS pilots may have higher density and/or higher power compared to other downlink reference signals. Thus, OTA-RSs may enhance uplink pre-equalization in OTA-FL training rounds. A WTRU and/or a WTRU group may be configured to participate in OTA-FL training rounds (e.g., configuration of OTA-RS allocation, OTA-RS reception, and/or how to map the locally updated AI/ML parameters to the uplink resources).

One or more WTRUs may be configured to participate in OTA-FL training rounds and/or to enable OTA-FL transmissions through uplink pre-equalization (e.g., with the goal of coherent reception), which may be applicable to Time Division Duplex (TDD) and/or Frequency Division Duplex (FDD) wireless communication systems.

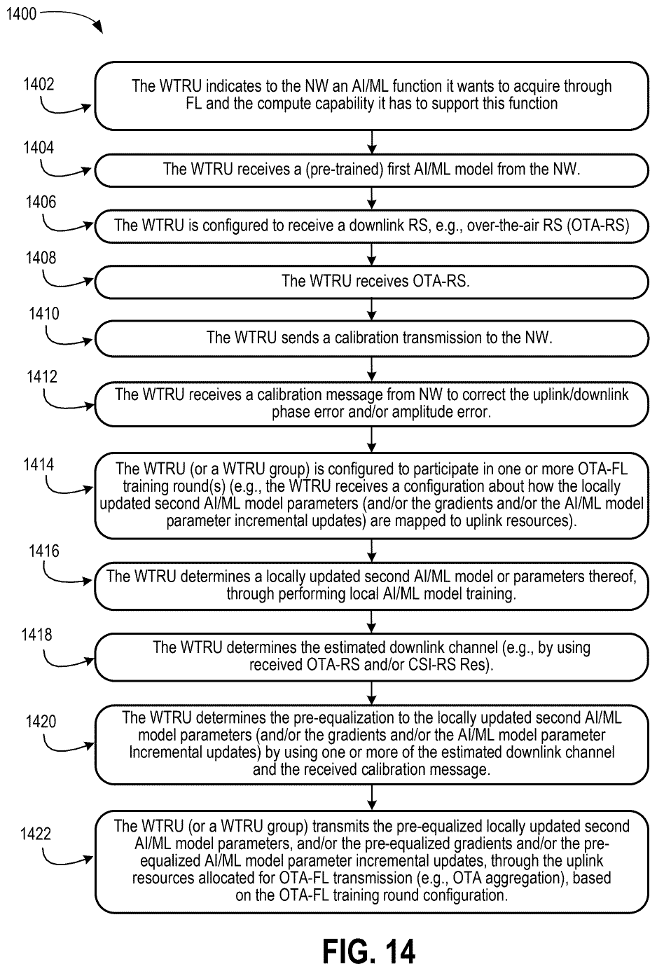

Examples of WTRU procedures for enabling OTA-FL transmissions using uplink pre-equalization, with the goal of coherent reception, are listed below, and are described in further detail with reference to FIG. 14 herein below. A WTRU may indicate to a NW an AI/ML function that is desired to be acquired through FL and/or the compute capability available to support the function. The WTRU may indicate that it has an initial AI/ML model (e.g., which may be locally trained) and/or an indication of the model's performance.

The WTRU (or a WTRU group) may receive a first AI/ML model (e.g., potentially pre-trained) and/or a part of a first AI/ML model from the NW. The pre-trained first AI/ML model (e.g., global) may be a common neural network architecture, and may be configured to perform a same and/or similar function.

The WTRU may be configured to receive a downlink RS (e.g., (OTA-RS). The WTRU may use the received OTA-RS REs for one or more of uplink and/or downlink channel calibration, downlink channel estimation, and/or determining the uplink pre-equalization in OTA-FL training rounds. The OTA-RS may be orthogonal known pilot sequences. The OTA-RS density in the frequency-domain may be based on delay spread. The OTA-RS density in the time-domain may be based on WTRU speed. The OTA-RS may be periodic, semi-persistent, and/or aperiodic.

The WTRU may receive a downlink reference signal (e.g., OTA-RS). The WTRU may send a calibration transmission to the NW, for example, after receiving one or more downlink reference signals (e.g., OTA-RS, PT-RS, and/or CSI-RS). The WTRU may determine the calibration transmission (e.g., pre-equalized symbols) as a response to OTA-RS over multiple symbols and/or slots to enable the NW to assess the quality of an uplink signal over the time (e.g., multiple uplink symbols that follows the received OTA-RS REs). b. The calibration transmission may include a multi-symbol response in the symbols, which may be later utilized for the uplink transmissions in the OTA-FL training rounds. The calibration transmission may be periodic, semi-persistent, and/or aperiodic.

The WTRU may receive a calibration message from the NW to correct an uplink phase error, a downlink phase error, and/or an amplitude error. The calibration message may indicate how the WTRU adjusts the phase and amplitude (e.g., per RE). The calibration message may include parameters for enabling a WTRU to perform the predictions on the channel aging and/or the predictions for pre-equalization. The calibration message may indicate which set of REs may be qualified for the uplink transmission in OTA-FL training rounds (e.g., first two OFDM symbols after OTA-RS may be qualified, while the next OFDM symbols may be disqualified).

The WTRU (or a WTRU group) may be configured to participate in one or more OTA-FL training rounds. The WTRU may receive a request and/or indication to participate in OTA-FL training rounds for updating the model parameters of the received first AI/ML model. The WTRU may receive an indication to identify which parts of the AI/ML model will be trained and/or updated through the OTA-FL training rounds (e.g., only specific layers (e.g., a last few layers) may be trained).

The WTRU may receive a configuration to send one or more of parameters. The parameters may include the locally updated second AI/ML model parameters for the AI/ML model being locally trained. (e.g., weights and/or biases). The parameters may include AI/ML model parameter incremental updates (e.g., a difference between the parameters of the locally updated second AI/ML model and a reference AI/ML model). The reference AI/ML model may be, for example, a most recently received ML model from the NW (e.g., as result of aggregation and/or the initial AI/ML model configured by the NW). The parameters may include a gradient, a set of gradients, and/or a function of the gradients, of the loss function with respect to the AI/ML model parameters measured by the WTRU during local training and/or loss computations. In an example scenario, the optimizer function may be in the NW.

The WTRU may receive uplink resource allocations for OTA-FL training rounds, which may be common for each of the WTRUs participating in the same one or more OTA-FL training rounds. Each of a plurality of WTRUs may use the same uplink resources to transmit the locally updated second AI/ML model parameters, the gradients and/or the AI/ML model parameter incremental updates. The WTRU may receive the OTA-RS allocations as a part of the uplink resource allocation for OTA-FL training rounds.

The WTRU may receive a configuration regarding how the locally updated second AI/ML model parameters, the gradients, and/or the AI/ML model parameter incremental updates may be mapped to uplink resources.

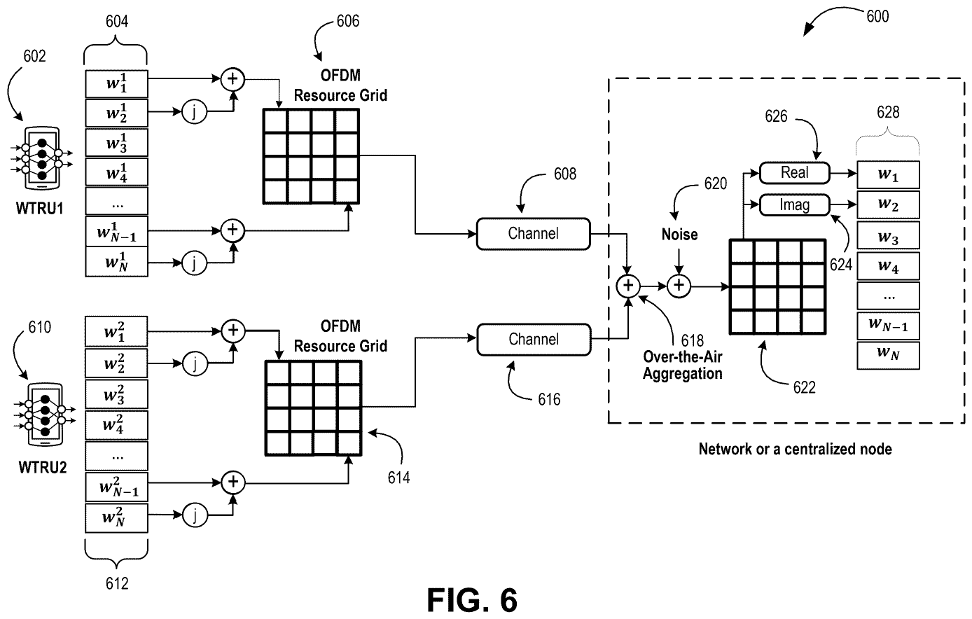

As illustrated and described in further detail with reference to FIG. 6, an example is shown with N real-valued AI/ML parameters transmitted without any encoding and/or digital modulation to achieve over-the-air aggregation, where each of two AI/ML model parameters may be combined as the real-part and imaginary-part of a complex symbol. The corresponding complex symbol may be mapped to an uplink RE. In this example, N/2 uplink REs may be utilized to accommodate the transmission of N real-valued AI/ML parameters in an OTA-FL manner.

Each real-valued AI/ML model parameter may be mapped to β∈ [symbol] ⁺ uplink REs to enhance the OTA aggregation accuracy (e.g., for β=2, an AI/ML model parameter may be mapped to two uplink REs). The sign of symbols in uplink REs may be alternated to further reduce the phase errors (e.g., for β=2, an AI/ML model parameter may be multiplied with +1 and −1 to create symbols to be mapped into two uplink REs). In this example, βN uplink REs may be utilized to accommodate the transmission of N real-valued AI/ML parameters in an OTA-FL manner.

The WTRU may receive a configuration regarding which type of uplink pre-equalization (e.g., phase correction, channel inversion, and/or truncated channel inversion) may be assumed. The WTRU may receive training related information (e.g., loss function, learning rate, and/or a set of thresholds to monitor the training progress).

The WTRU may determine a locally updated second AI/ML model and/or parameters thereof, through performing local AI/ML model training. The WTRU may train the entire (or part of) the second AI/ML model based on the received configuration. The WTRU may perform fine-tuning of the received first AI/ML model. The WTRU may send a message indicating that the locally updated second AI/ML model has been sufficiently trained to the NW (e.g., when the WTRU detects that the training is sufficient through evaluating the performance of the locally updated second AI/ML model based on the configured thresholds for performance monitoring).

The WTRU may determine the estimated downlink channel (e.g., by using received OTA-RS and/or CSI-RS REs). The WTRU may determine the pre-equalization to the locally updated second AI/ML model parameters, the gradients, and/or the AI/ML model parameter incremental updates by using one or more of the estimated downlink channel and/or the received calibration message. The WTRU (or a WTRU group) may transmit the pre-equalized locally updated second AI/ML model parameters, the pre-equalized gradients, and/or the pre-equalized AI/ML model parameter incremental updates through the uplink resources allocated for OTA-FL transmission (e.g., OTA aggregation), based on the OTA-FL training round configuration.

The network (NW) may identify WTRUs requesting FL-based training of an AI/ML model for the same and/or similar function. The NW may identify a common AI/ML model architecture. For example, the WTRUs may train AI/ML models for similar classification functions, where the WTRUs have different subsets of classes. This may lead to a common neural network architecture in the first set of layers, while the last few layers may be specialized for each WTRU corresponding to their classes.

The NW may create one or more WTRU groups based on WTRU computed capabilities. The NW may select one of the WTRUs to provide its AI/ML model to the NW. The NW may select one of the provided AI/ML models, and/or may select another ML model to be used as the (possibly pre-trained) first AI/ML model for the WTRU group. The NW may transmit a (possibly pre-trained) first AI/ML model for the WTRU group. The NW may transmit OTA-RS to the WTRU (or the WTRU group). The NW may receive a calibration transmission from the WTRU (or the WTRU group). The NW may determine whether the WTRU is qualified, partially qualified, and/or disqualified for participating in OTA-FL training rounds through the received calibration transmission. The NW may utilize the received calibration transmission for determining how many consecutive OFDM symbols may be supported (e.g., per WTRU) in the uplink resource allocations for the OTA-FL training rounds.

The NW may send a calibration message to the WTRU (or the WTRU group). The calibration message may include information about the (e.g., measured) downlink and/or uplink channels' amplitude error and/or phase error determined by the NW. The calibration message may provide feedback on the (e.g., measured) analog and/or digital errors per RE, per OFDM symbol, per subcarrier, per RB set, and/or per RBGs. The NW may configure the WTRU (or a WTRU group) to participate in one or more OTA-FL training rounds. The NW may receive the OTA-aggregated locally updated second AI/ML model parameters, gradients, and/or AI/ML model incremental updates from the WTRUs in an OTA-FL manner.

In OTA-FL, each participating WTRU may locally train an AI/ML model for the same (or similar) function. When a WTRU is configured to pre-equalize the transmission of locally updated (e.g., trained) AI/ML model parameters, the pre-equalization may mitigate the effect of wireless channels. As shown in Equation (3), the performance of pre-equalization may depend on uplink channel estimation accuracy.

A new downlink reference signal, referred to as OTA-RS, may be utilized to improve channel estimation accuracy for REs used in OTA-FL. New OTA-RS pilots may have higher density and/or higher power as compared to other downlink reference signals. Thus, OTA-RSs may enhance uplink pre-equalization in OTA-FL training rounds. A WTRU (or a WTRU group) may be configured to participate in OTA-FL training rounds (e.g., configuration of OTA-RS allocation and reception and/or how to map the locally updated AI/ML model parameters to the uplink resources.). Procedures may be performed to configure one or more WTRUs to participate in OTA-FL training rounds and/or to enable OTA-FL transmissions through uplink pre-equalization with the goal of coherent reception, which may be applicable for TDD and/or FDD wireless communication systems.

The NW may initiate a WTRU capability exchange process by sending a message (e.g., a WTRUCapabilityEnquiry RRC message) to the WTRU. This message may include an indication requesting specific information regarding the WTRU's capabilities. The NW may include parameters in the message to specify which capabilities are desired by the WTRU. The NW may specify parameters related to WTRU's capability in supporting OTA-FL training in the WTRUCapabilityEnquiry message (e.g., the capability of performing uplink pre-equalization, and/or transmitting AI/ML model parameters).

Upon receiving a WTRUCapabilityEnquiry RRC message, the WTRU may respond with a WTRUCapabilityInformation RRC message accordingly. This message may include detailed information about the WTRU's capability in supporting OTA-FL training rounds. During the WTRU capability exchange process between the WTRU and the NW, one more parameters may be included. Parameters may include an indicator of whether a supporting OTA-FL is supported or not, an indicator of whether receiving a pre-trained first AI/ML model from the NW is supported or not, and/or an indicator of whether sending a calibration transmission (e.g., SRS) to the NW is supported or not.

Parameters may include an indicator of whether receiving a calibration message from the NW is supported or not, an indicator of whether correcting the phase error between the uplink channel and downlink channel (e.g., through the calibration message) is supported or not, and/or an indicator of whether correcting the amplitude error between the uplink channel and downlink channel (e.g., through the calibration message) is supported or not. Parameters may include an indicator of whether training of the pre-trained first AI/ML model is supported or not, an indicator of whether training of a part of the pre-trained first AI/ML model (e.g., only the last few layers) is supported or not, an indicator of whether sending the locally updated second AI/ML model parameters to the NW is supported or not, and/or an indicator of whether sending the gradients to the NW is supported or not.

Parameters may include an indicator of whether sending the AI/ML model parameter incremental updates (e.g., the difference between the parameters of the locally updated second AI/ML model and a reference AI/ML model) to the NW is supported or not, an indicator of whether receiving OTA-RS is supported or not, and/or an indicator of whether performing the downlink channel estimation (e.g., by using the received OTA-RS and/or CSI-RS REs) is supported or not. Parameters may include an indicator of whether using a denoising filter (e.g., Gaussian filter, median filter, and/or bilateral filter) for improving downlink channel estimation accuracy is supported or not, and/or an indicator of whether performing the uplink pre-equalization (e.g., phase correction, channel inversion, and/or truncated channel inversion) is supported or not.

Parameters may include an indicator of whether determining the pre-equalization to the transmission of locally updated second AI/ML model parameters is supported or not, an indicator of whether determining the pre-equalization to the transmission of gradients is supported or not, and/or an indicator of whether determining the pre-equalization to the transmission of AI/ML model parameter incremental updates is supported or not. Parameters may include an indicator of whether transmitting the pre-equalized locally updated second AI/ML model parameters is supported or not, an indicator of whether transmitting the pre-equalized gradients is supported or not, and/or an indicator of whether transmitting the pre-equalized AI/ML model parameter incremental updates is supported or not.

Referring now to FIG. 6, a diagram 600 showing an example of mapping locally updated second AI/ML model parameters to uplink resources during over-the-air federated learning (OTA-FL) transmissions is illustratively depicted.

In examples, the NW may know a WTRU's capability to support the OTA-FL training through uplink pre-equalization (e.g., with a goal of coherent reception) based on a WTRU capability exchange process, as described in detail herein above. For WTRUs that may be capable of supporting such mapping functions and/or features (e.g., participating in OTA-FL training rounds), the WTRU may receive one or more parameters, configured by the NW, which may include, for example, a configuration to send one or more parameters, such as locally updated second AI/ML model parameters, the gradients, and/or the AI/ML model parameter incremental updates, in an OTA-FL manner. The WTRU may receive uplink resource allocations for OTA-FL training rounds, enabling the transmission of pre-equalized locally updated second AI/ML model parameters, the pre-equalized gradients, and/or the pre-equalized AI/ML model parameter incremental updates.

A configuration may be received regarding how the locally updated second AI/ML model parameters (and/or the gradients and/or the AI/ML model parameter incremental updates) may be transmitted in OTA-FL manner. FIG. 6 presents an example in which N real-valued AI/ML parameters may be transmitted without any encoding and/or digital modulation to achieve over-the-air aggregation. In examples, each of two AI/ML model parameters may be combined as the real-part and imaginary-part of a complex symbol. Then, a corresponding complex symbol may be mapped to an uplink RE.

In an example, N/2 uplink REs may be utilized to accommodate the transmission of N real-valued AI/ML parameters in an OTA-FL manner. In another example, each real-valued AI/ML model parameter may be mapped to β∈ [symbol] ⁺ uplink Res, which may enhance the OTA aggregation accuracy (e.g., for β=2, an AI/ML model parameter may be mapped to two uplink REs). The signs of symbols in uplink REs may be alternated to further reduce the phase errors (e.g., for β=2, an AI/ML model parameter may be multiplied with +1 and −1 to create symbols to be mapped into two uplink REs). In an example, BN uplink REs may be utilized to accommodate the transmission of N real-valued AI/ML parameters in an OTA-FL manner.

The configuration for the OTA-RS, which may be a new downlink reference signal, may include various operations. The OTA-RS may target improving the downlink channel estimation accuracy per RE level. The OTA-RS may enable the uplink pre-equalization in OTA-FL training rounds. The OTA-RS may be orthogonal known pilot sequences. The OTA-RS may separate antenna ports using time, frequency, and/or code domain orthogonalization techniques. The OTA-RS allocations may be non-specific to any WTRUs. For example, in TDD, when the channel reciprocity exists, multiple WTRUs may simultaneously use the same OTA-RS allocations and/or receive the same OTA-RS pilots. The OTA-RS allocations may be WTRU-specific. For example, in FDD, when there is no channel reciprocity, the OTA-RS pilots may be configured for each WTRU at the NY using calibration transmissions (e.g., SRS). The OTA-RS may have a higher density than other downlink reference signals. The OTA-RS density in the frequency domain may be based on delay spread. The OTA-RS density in the time domain may be based on the WTRU speed.

In an example, a first WTRU 602 (e.g., WTRU 1) may include locally updated second AI/ML model parameters

$${w}_{1}^{1} , {w}_{2}^{1} , {w}_{3}^{1} , {w}_{4}^{1} , … , {w}_{N - 1}^{1} , {w}_{N}^{1} ,$$

depicted collectively at block 604, which may be further processed to produce a representation where pairs of AI/ML model parameters may be mapped to an OFDM resource grid 606 for transmission. Similarly, a second WTRU 610 (e.g., WTRU 2) may process its locally updated AI/ML model parameters

$${w}_{1}^{2} , {w}_{2}^{2} , {w}_{3}^{2} , {w}_{4}^{2} … , {w}_{N - 1}^{2} , {w}_{N}^{1} ,$$

depicted collectively at block 612, to generate its corresponding mapping of its local AI/ML model parameters mapping to an OFDM resource grid 614, noting that resource grid 606 and resource grid 614 may be the same OFDM resource grid.

The WTRUs 602 and/or 610 may transmit their local AI/ML model parameters on their respective OFDM resource grids 606, 614 through distinct channels (e.g., channels 608, 616). The network or a centralized node received the local AI/ML model parameters transmitted by The WTRUs 602 and 610. At 618, at the receiver transmitted signals are aggregated over the air, which may combine the received signals in a wireless medium. The aggregated signal may then be further distorted by noise 620 before being further processed. An aggregated resource grid 622 may be constructed, and may include combined contributions from multiple WTRUs. Real 626 and/or imaginary 624 components may be utilized to generate the reconstructed parameters w₁, w₂, w₃, w₄, . . . , w_{N-1}, w_{N}, collectively shown at block 628.

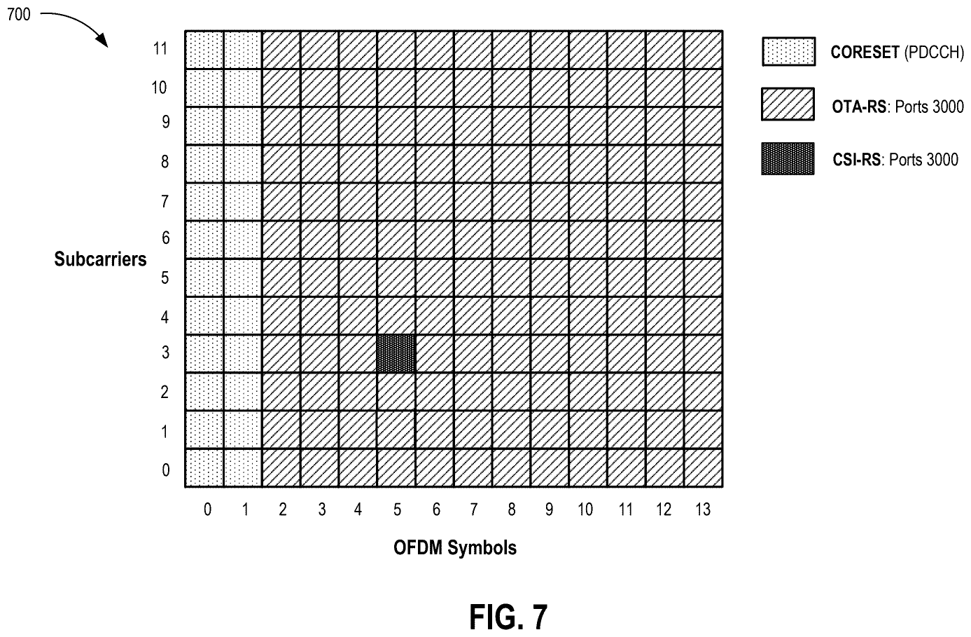

Referring now to FIG. 7, a diagram 700 showing an example of resource allocation (e.g., downlink resource allocation) for OTA-RS and CSI-RS with 1 port is illustratively depicted. The downlink resource allocation may be shown for a normal density CSI-RS and high-density OTA-RS for 1 port. In this example, OTA-RS may have a higher density in time/frequency than CSI-RS, and may enhance the downlink channel estimation accuracy, which may improve uplink pre-equalization in OTA-FL training rounds. As shown in FIG. 7, 143 REs per RB-slot may be allocated for OTA-RS, while there may be only a single RE per RB-slot for CSI-RS.

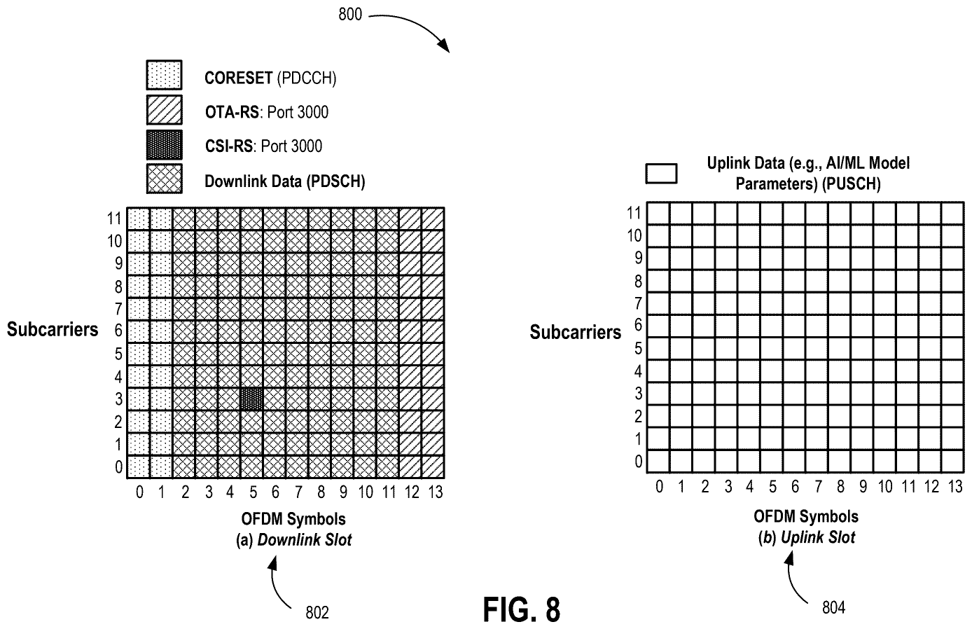

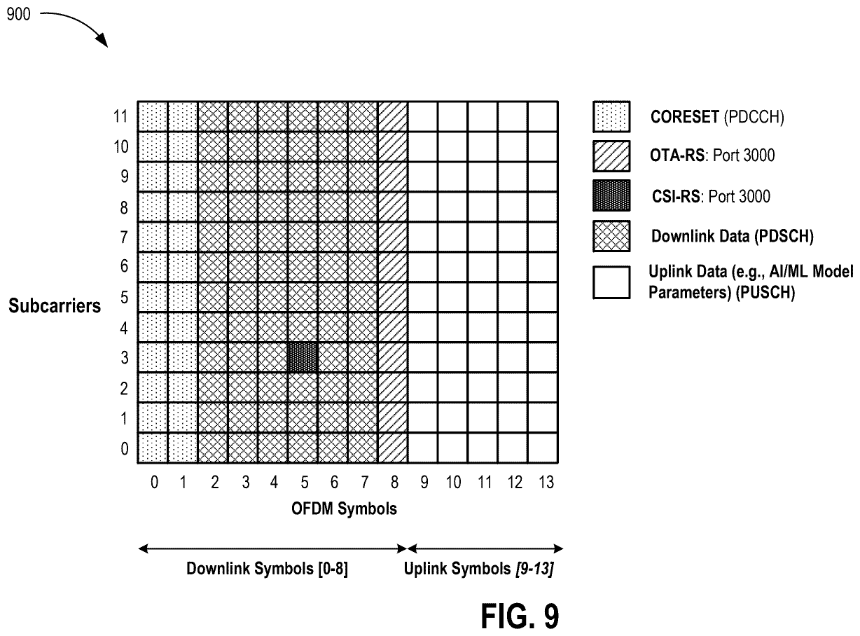

The WTRU may use the received OTA-RS REs in one or more of uplink and/or downlink channel calibration, downlink channel estimation, and/or determining the uplink pre-equalization in OTA-FL training rounds. The WTRU may send a calibration transmission to the NW after receiving the OTA-RS. The NW may send a calibration message to the WTRU (or the WTRU group). The NW may select the OTA-RS resource pattern and/or the uplink resource pattern for the OTA-FL transmissions (e.g., as shown in further detail in FIG. 8 and/or FIG. 9).

Referring now to FIG. 8, a diagram 800 showing an example of resource allocation grids when a downlink slot is followed by an uplink slot is illustratively depicted.

FIG. 8 shows a plot of another example of downlink 802 and/or uplink 804 resource allocations for 1 port, where the downlink slot may be followed by the uplink slot. In order to mitigate the effect of channel aging, the OTA-RS REs may be allocated in, for example, the last two OFDM symbols in the downlink slot, i.e., 12th and 13th OFDM symbols (e.g., as close as possible to the upcoming uplink slot). There may be 24 OTA-RS REs per RB-slot resource grid. Thus, the WTRU (or the WTRU group) may utilize the received OTA-RS REs in the downlink slot to determine the pre-equalization for the subsequent uplink slot. Then, the WTRU (or the WTRU group) may transmit the pre-equalized locally updated second AI/ML model parameters, the pre-equalized gradients, and/or the pre-equalized AI/ML model parameter incremental updates using the uplink resources allocated for OTA-FL transmission. In examples, each of the uplink resource element in the RB-slot resource grid may be allocated for the OTA-FL transmissions.

Referring now to FIG. 9, a diagram 900 showing an example of resource allocation when the downlink and/or the uplink are scheduled in the same slot is illustratively depicted.

FIG. 9 shows another example of downlink and uplink resource allocations for 1 port, where the downlink and uplink resources may be configured in the same slot. The first 9 OFDM symbols in the slot may be configured for the downlink, while the last 5 OFDM symbols in the slot may be configured for the uplink. In order to mitigate the effect of channel aging, the OTA-RS REs may be allocated in the 8th OFDM symbol, which may be the last OFDM symbol before the uplink resources. There may be 12 OTA-RS REs per RB-slot. The WTRU may use the received OTA-RS REs in the downlink OFDM symbols for the pre-equalization for OTA-FL transmission in the uplink, where there may be 60 OFDM symbols per RB-slot allocated for the OTA-FL transmission.

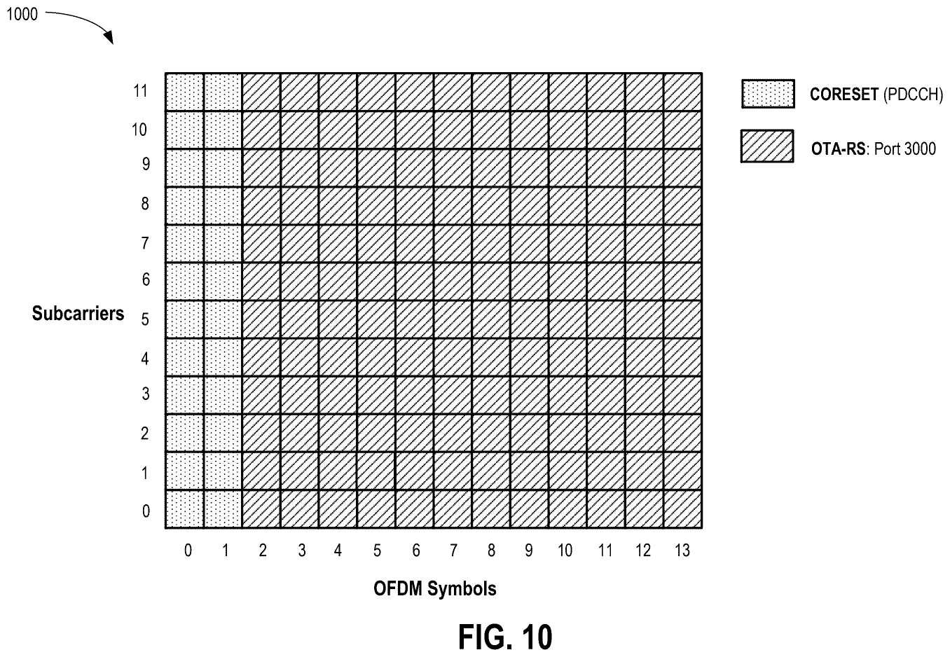

Referring now to FIG. 10, a diagram 1000 showing an example of resource allocation for OTA-RS with 1 port is illustratively depicted. In this example of downlink resource allocation for 1 port, there may be only OTA-RS allocations during the OTA-FL training rounds (e.g., without CSI-RS allocations). For example, 144 REs per RB-slot may be allocated for OTA-RS.

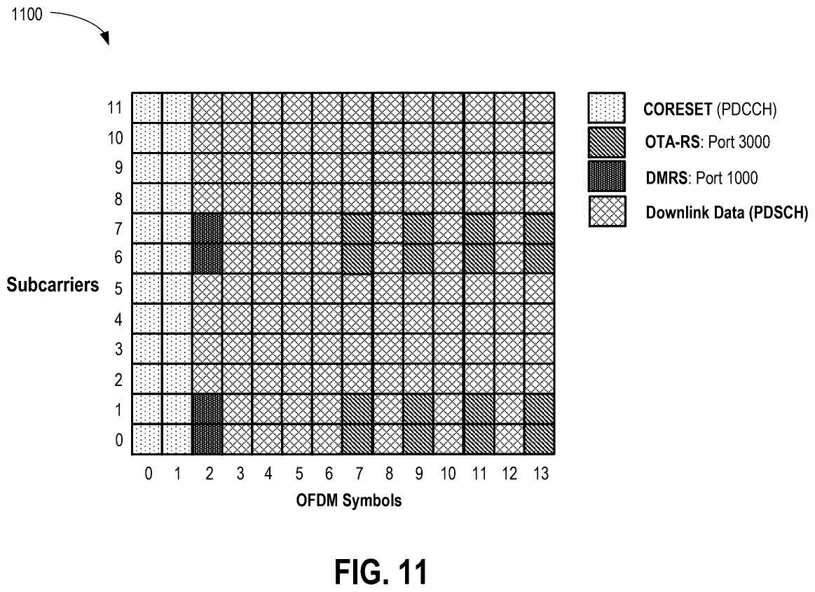

Referring now to FIG. 11, a diagram 1100 showing an example of resource allocation for OTA-RS, DMRS and data with 1 port is illustratively depicted.

In the example of downlink resource allocation with OTA-RS, DMRS, and data REs for 1 port shown in FIG. 11, the density of OTA-RS allocations may be lower as compared to the density of OTA-RS allocations shown in FIG. 10. For example, 16 REs per RB-slot resource grid may be allocated for OTA-RS. The OTA-RS density in time and frequency may be determined according to how the channel varies over time and/or frequency.

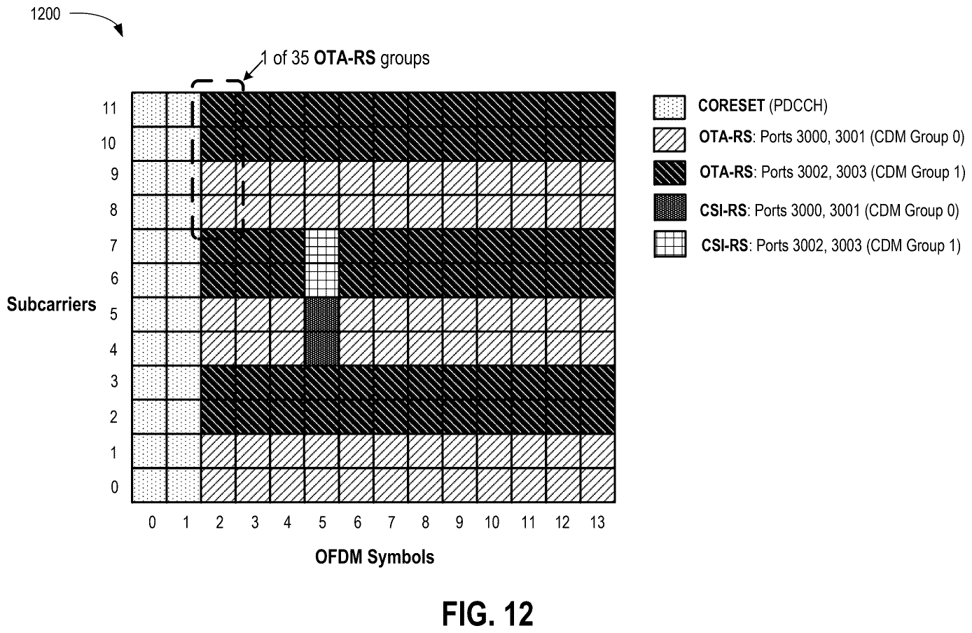

Referring now to FIG. 12, a diagram 1200 showing an example of resource allocation for OTA-RS and CSI-RS with 4 ports is illustratively depicted.

In the example of downlink resource allocation for 4 ports shown in FIG. 12, there may be normal density CSI-RS and/or high-density OTA-RS. The OTA-RS may be grouped into 35 groups with the same pattern as the CSI-RS.

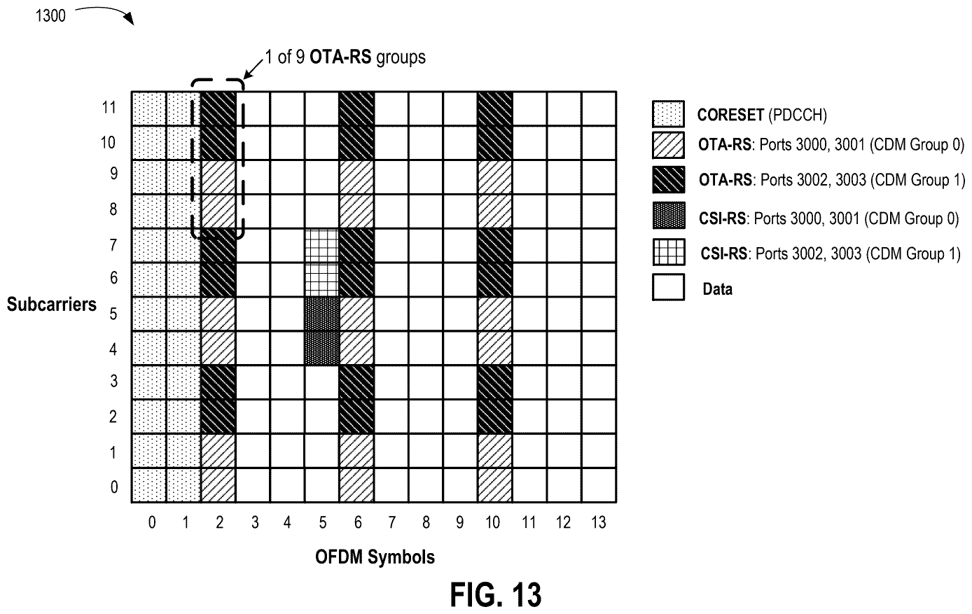

Referring now to FIG. 13, a diagram 1300 showing an example of resource allocation for OTA-RS, CSI-RS, and data with 4 ports is illustratively depicted.

In the example of downlink resource allocation for 4 ports shown in FIG. 13, there may be data, normal density CSI-RS, and/or high-density OTA-RS. The OTA-RS may be grouped into 9 groups with the same pattern as the CSI-RS. A configuration regarding how to perform the uplink pre-equalization (e.g., phase correction, channel inversion, and/or truncated channel inversion) may be received.

Training related information may include one or more of a learning algorithm, learning rates, and/or regularization parameters. The training related information may include a total number of training iterations for each training round, a loss function (e.g., binary cross entropy, and/or mean square error), thresholds to monitor the AI/ML model training progress, and/or an indicator to identify which parts of the AI/ML model may be trained and/or updated through OTA-FL training rounds (e.g., only last few layers may be trained).

Referring now to FIG. 14, a diagram 1400 showing an example method including WTRU procedures for enabling OTA-FL transmissions using uplink pre-equalization is illustratively depicted.

At 1402, the WTRU may indicate to the NW an AI/ML function it wants to acquire through FL and the compute capability it has to support this function. At 1404, the WTRU may receive a pre-trained first AI/ML model from the NW. At 1406, the WTRU may be configured to receive a downlink reference signal (RS), such as over-the-air RS (OTA-RS). At 1408, the WTRU may receive OTA-RS. At 1410, the WTRU may send a calibration transmission to the NW.

At 1412, the WTRU may receive a calibration message from the NW to correct the uplink/downlink phase error and/or amplitude error. At 1414, the WTRU or a WTRU group may be configured to participate in one or more OTA-FL training rounds. For example, the WTRU may receive a configuration about how the locally updated second AI/ML model parameters, and/or the gradients, and/or the AI/ML model parameter incremental updates, are mapped to uplink resources. At 1416, the WTRU may determine a locally updated second AI/ML model or parameters thereof through performing local AI/ML model training. At 1418, the WTRU may determine the estimated downlink channel, for example, by using received OTA-RS and/or CSI-RS REs.

At 1420, the WTRU may determine the pre-equalization to the locally updated second AI/ML model parameters, and/or the gradients, and/or the AI/ML model parameter incremental updates, by using one or more of the estimated downlink channel and/or the received calibration message. At 1422, the WTRU or a WTRU group may transmit the pre-equalized locally updated second AI/ML model parameters, and/or the pre-equalized gradients, and/or the pre-equalized AI/ML model parameter incremental updates, through the uplink resources allocated for OTA-FL transmission (e.g., OTA aggregation), based on the OTA-FL training round configuration.

A plurality of signals may be defined to enable a WTRU (or a WTRU group) to participate in OTA-FL training rounds and/or to perform uplink pre-equalization in OTA-FL. The signals may include a (possibly pre-trained) first AI/ML model transmitted from the NW to the WTRU (or a WTRU group), a request to send a calibration transmission transmitted from the NW to the WTRU (or a WTRU group), a calibration transmission transmitted from the WTRU to the NW, and/or a calibration message transmitted from the NW to the WTRU.

The signals may include a configuration for participating in OTA-FL rounds transmitted from the NW to the WTRU. An indication to identify which parts of the AI/ML model may be trained and/or updated during OTA-FL training rounds may be transmitted from the NW to the WTRU. A configuration for uplink resource allocations for OTA-FL training rounds may be transmitted from the NW to the WTRU. The signals may include an indication instructing the WTRU to transmit the locally updated second AI/ML model parameters, which was received from the NW, a configuration indicating how the locally updated second AI/ML model parameters may be mapped to uplink resources transmitted from the NW to the WTRU.

The signals may include an indication instructing the WTRU to transmit the gradients, which was received from the NW, a configuration about how the gradients are mapped to uplink resources transmitted from the NW to the WTRU, an indication instructing the WTRU to transmit the AI/ML model parameter incremental updates (which may be received from the NW), a configuration about how the AI/ML model parameter incremental updates may be mapped to uplink resources transmitted from the NW to the WTR, a configuration for OTA-RS transmitted from the NW to the WTRU, and/or OTA-RS transmitted from the NW to the WTRU.

Pre-equalized locally updated second AI/ML model parameters may be transmitted from the WTRU to the NW through the uplink resource allocated for OTA-FL. Pre-equalized gradients may be transmitted from the WTRU to the NW through the uplink resource allocated for OTA-FL. Pre-equalized AI/ML model parameter incremental updates may be transmitted from the WTRU to the NW through the uplink resource allocated for OTA-FL.

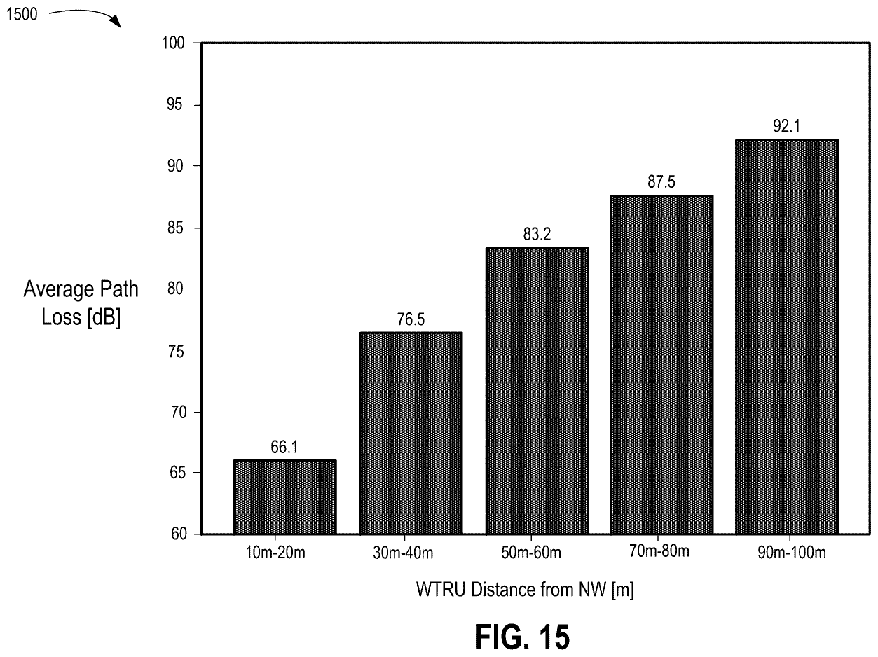

Referring now to FIG. 15, a diagram 1500 showing an example of average path loss for each WTRU cluster is illustratively depicted.

FIG. 15 shows numerical results which may be presented for the performance evaluation of an example implementation which may enable OTA-FL through uplink pre-equalization. A channel estimation use case may be considered (e.g., the AI/ML-based channel estimator may be learned through OTA-FL training rounds). The simulations may be performed using, for example, an open-source Python library (e.g., Sionna) for the link-level simulations based on an open-source machine learning framework (e.g., TensorFlow).

The simulation parameters may be summarized in Table 1, where there may be 5 outdoor WTRUs in a TDD system participating in OTA-FL training rounds for learning the AI/ML-based channel estimator. Each WTRU may be placed in a WTRU cluster with a range of horizontal distanced from gNB, as shown in Table 1 (e.g., WTRU Cluster #1 with a random horizontal WTRU-gNB distance in [10 m, 20 m], while WTRU Cluster #5 with a random horizontal WTRU-gNB distance in [90 m, 100 m]). The WTRUs may be mobile with a random velocity between, for example, 3 km/h and 60 km/h. This may create diverse channel conditions (e.g., path loss and/or fading) for each WTRU, which may motivate utilizing an AI/ML-based channel estimator through OTA-FL that may generalizes sufficiently well under diverse WTRU settings and/or channel conditions. In the example shown in FIG. 15, an illustration of how the average path loss varies for each WTRU cluster (e.g., a WTRU in Cluster #3 with a random horizontal WTRU-gNB distance in [50 m, 60 m] experiences 83.2 dB path loss on average) is depicted.

TABLE 1
Simulation parameters

| | |
|---|---|
| Number of gNB | 1 |
| Number of WTRU | 5 |
| Number of Antenna | 1 |
| at gNB | |
| Number of Antenna | 1 |
| at WTRU | |
| Transmit power | 41 dBm |
| at gNB (Maximum) | |
| Transmit power | 23 dBm |
| at WTRU (Maximum) | |
| Horizontal WTRU-gNB | 5 WTRU Clusters with a |
| Distance | single WTRU per cluster: |
| | WTRU Cluster #1: [10 m, 20 m] |
| | WTRU Cluster #2: [30 m, 40 m] |
| | WTRU Cluster #3: [50 m, 50 m] |
| | WTRU Cluster #4: [70 m, 80 m] |
| | WTRU Cluster #5: [90 m, 100 m] |
| Channel Model | UMi (Outdoor) |
| Channel Normalization | False (Disabled) |
| Subcarrier Spacing | 30 kHz |
| Number of RBs | 24 |
| Number of subcarriers | 288 |
| Bandwidth | 10 MHz |
| WTRU Velocity | [3 km/h, 60 km/h] |

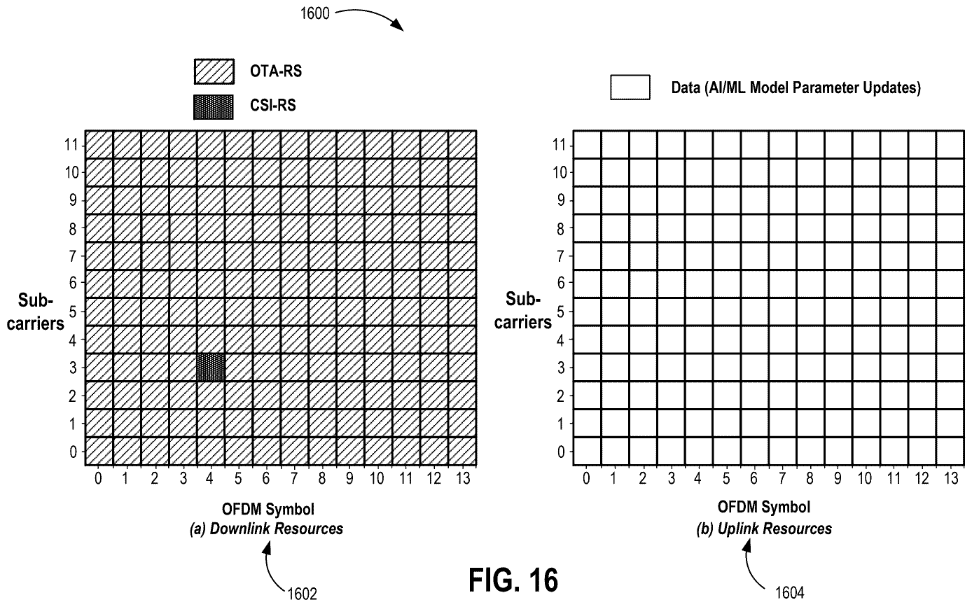

Referring now to FIG. 16, a diagram 1600 showing an example of an OFDM resource grid during OTA-FL training rounds is illustratively depicted.

During the OTA-FL training rounds, an OFDM resource grid with the corresponding downlink and uplink resources, as shown in FIG. 16, may be utilized. At 1602, the new OTA-RS may have a higher density than CSI-RS (e.g., 167 OTA-RS REs per RB-slot compared to a single CSI-RS RE per RB-slot). In examples, each of the uplink resource elements in the PRB may be reserved to transmit the AI/ML model parameter incremental updates. In the simulations, the downlink and uplink channels may be considered as reciprocal since it may be a TDD system. Thus, by using the received high-density OTA-RS REs and normal density CSI-RS REs, the uplink channel estimation may be performed through a least square estimator and/or a 2D Gaussian denoising filter, which may be employed for improving the uplink channel estimation accuracy per RE level. Then, the uplink channel estimates may be utilized in channel inversion-based pre-equalization, which may enable the uplink pre-equalization during OTA-FL training rounds.

Table 2 presents the parameters related to the AI/ML model training through OTA-FL. The training dataset may be developed through, for example, 100,000 ground-truth complex channel samples, where each WTRU cluster may have an equal contribution to the dataset (e.g., 20,000 complex channel samples per WTRU cluster). Each complex channel sample may have a size of 14×288 (e.g., 14 OFDM symbols and 288 subcarriers. The dataset may be split into, for example, 80% for training, 10% for validation, and 10% for test. The test dataset with 2,000 channel samples from each WTRU cluster may have 10,000 samples in total. The test dataset may be considered as the global test dataset at the NW, while the training and validation datasets may be located at the corresponding WTRUs for local AI/ML model training. Therefore, after the local AI/ML model training, the NW may receive the OTA aggregated AI/ML model parameter incremental updates for obtaining a global AI/ML-based channel estimator. The NW may test its performance through the global test dataset.

TABLE 2
Parameters on AI/ML model training through OTA-FL

| Training Dataset Size | 100,000 channel samples in total: |
|---|---|
| | 20,000 channel samples from each WTRU cluster |
| | Each channel sample includes the ground-truth complex |
| | channel for 1 slot with the size of 14 × 288. |
| Dataset Split | 80% Training \| 10% Validation \| 10% Test |
| Optimizer | Adam |
| Learning Rate | 0.0001 |
| Batch Size | 32 |
| Local Epochs per OTA-FL | 3 |
| Training Round | |
| Model Params | 71,666 |
| OTA-FL Communication Overhead | $9 Uplink Slots per OTA - FL Training Round = ⌈ \frac{71666}{2 \times 4032} ⌉$ |
| Number of OTA-FL | |
| Training Rounds | 60 |

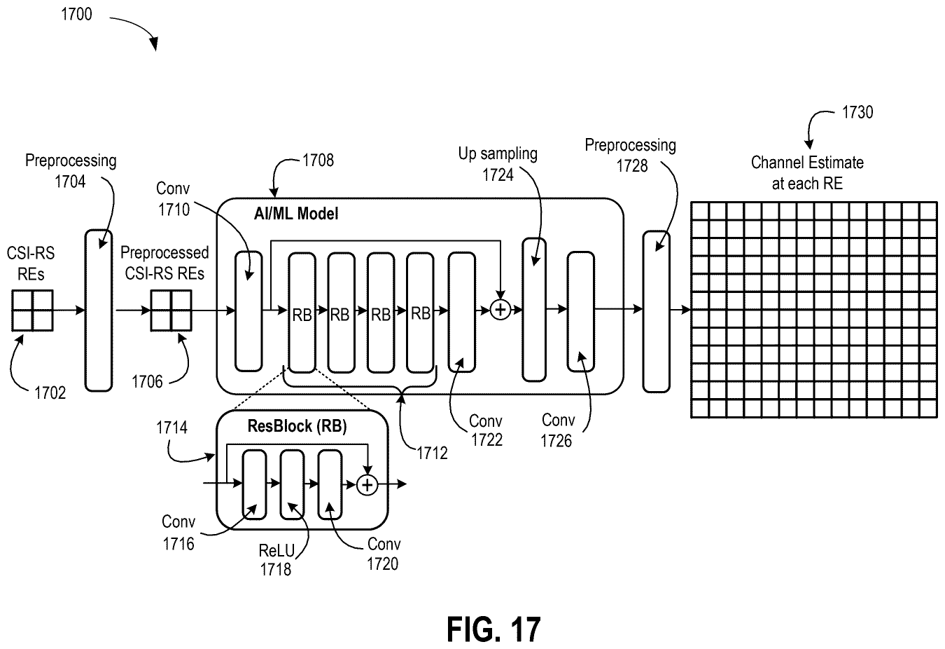

Referring now to FIG. 17, a diagram 1700 showing an example of a ReEsNet model for AI/ML-based channel estimator is illustratively depicted.

A ResNet model may be utilized for the AI/ML-based channel estimator, which may have, for example, 71,666 real-valued parameters. After each WTRU performs the local AI/ML model training, each of two AI/ML model parameter incremental updates may be combined as the real-part and imaginary-part of a complex data symbol, and the corresponding complex symbol may be mapped to an uplink RE, as illustrated in FIG. 6. Since there may be 4032 uplink REs per slot and each may carry two AI/ML model parameter incremental updates, one OTA-FL training round may be completed in

$$9 = ⌈ \frac{71666}{2 \times 4032} ⌉$$

uplink slots, 60 OTA-FL training rounds may be performed to train a global AI/ML-based channel estimator, which may target generalizing sufficiently well for diverse channel conditions.

At 1702, CSI-RS REs (Channel State Information Reference Signal Resource Elements) may be received as input. These REs may represent raw channel information provided to the WTRU. At 1704, preprocessing may be performed on the CSI-RS REs. This preprocessing stage may prepare the raw data for subsequent convolutional operations by normalizing or filtering the input. At 1706, the preprocessed CSI-RS REs may undergo initial feature extraction via a convolutional layer 1710, which generates a feature map. This convolutional process may reduce the dimensionality and capture spatial relationships in the data.

At 1708, the AI/ML model may further process the extracted features. The AI/ML model includes residual blocks (ResBlock), such as the ResBlock 1714, which may perform iterative feature refinement to improve the quality of the learned representation. Each residual block may include several internal components, such as a convolutional layer 1716, a ReLU activation layer 1718, and another convolutional layer 1720. These components may enable the network to capture complex relationships in the data.

At 1722, a convolutional layer may process the outputs of the residual blocks to aggregate the learned features. This may involve further refining the spatial representation of the channel information. At 1724, an up-sampling operation may reconstruct the feature map to match the resolution of the of all REs. This up-sampling may ensure the final output aligns with the granularity of the channel state information. At 1726, additional convolutional operations may be performed to refine the up-sampled features further. This refinement may prepare the processed data for the final preprocessing stage. At 1728, a second preprocessing block may be applied to the refined features. This block may ensure the output is in a form suitable for generating channel estimates. At 1730, the channel estimate may be produced for each RE. This final output represents the estimated channel characteristics, which may be used by the WTRU for subsequent operations such as uplink pre-equalization or OTA-FL transmissions.

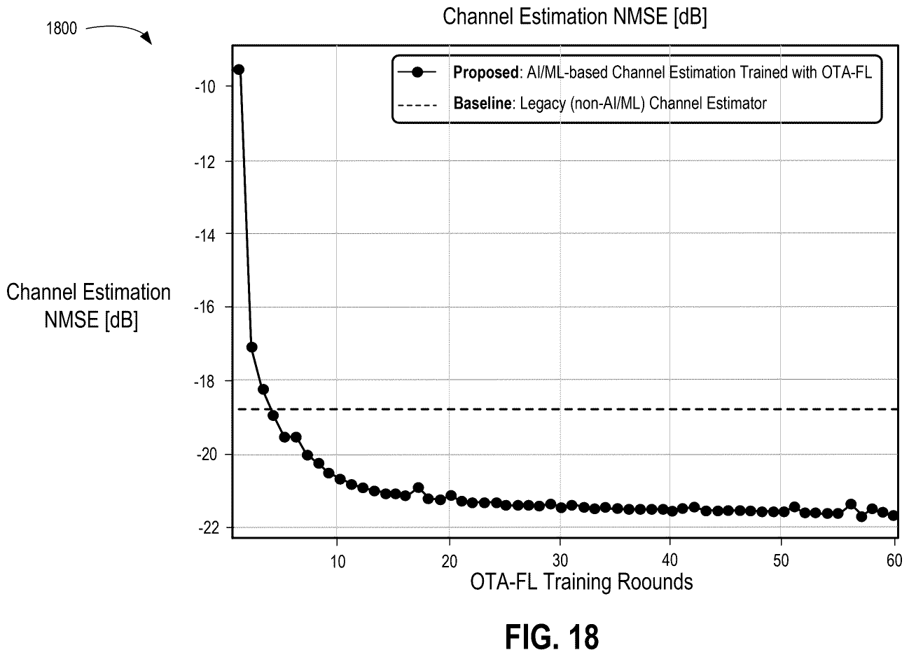

Referring now to FIG. 18, a diagram 1800 showing an example of a channel estimation normalized mean square error (NMSE) on a global test dataset during OTA-FL training rounds is illustratively depicted.

FIG. 18 shows the average channel estimation NMSE (normalized mean square error) on the global test dataset versus the OTA-FL training rounds. In an illustrative example, the global dataset with 10,000 channel samples may include 2,000 channel samples from each WTRU cluster expressed in Table 1. The AI/ML-based channel estimator trained with OTA-FL may be tested after each OTA-FL training round. The AI/ML-based channel estimator may be compared with the legacy (e.g., non-AI/ML) channel estimator using the least square channel estimator and linear interpolator. The legacy channel estimator may achieve-18.8 dB NMSE, which may be independent from the OTA-FL training rounds. The channel estimation accuracy of the AI/ML-based channel estimator may increase through the OTA-FL training rounds, where it may outperform the legacy channel estimator after the 4th OTA-FL training rounds. After some OTA-FL training rounds, the AI/ML-based channel estimator may converge to −21.6 dB NMSE, which may mean a 2.8 dB NMSE improvement in channel estimation.

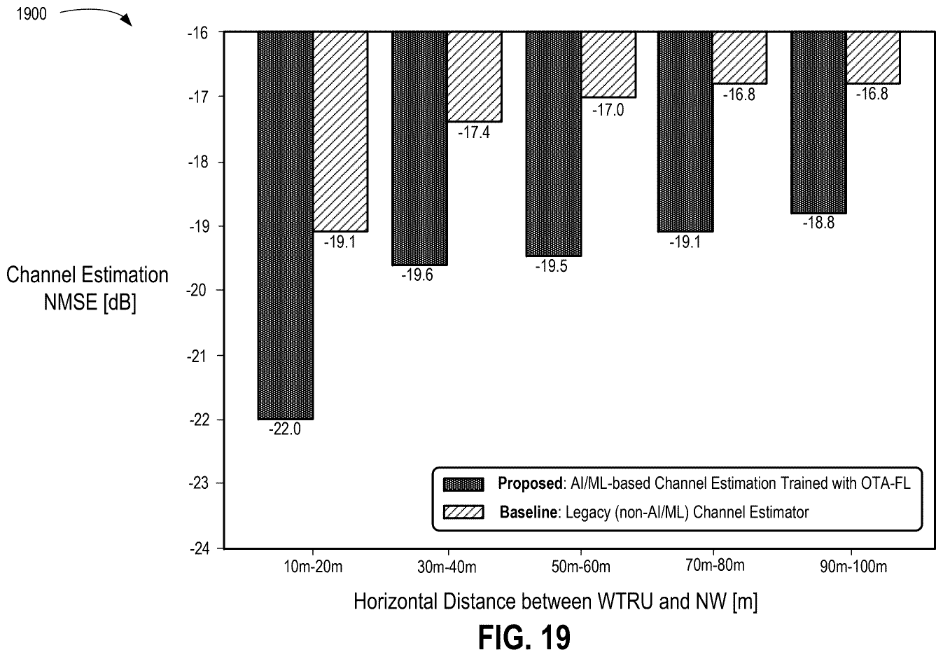

Referring now to FIG. 19, a diagram 1900 showing an example of a channel estimation NMSE on global test dataset per WTRU cluster is illustratively depicted.

It may be observed that in each of the WTRU clusters, the AI/ML-based channel estimator may outperform the legacy channel estimator. For example, the AI/ML-based channel estimator may reduce the channel estimation NMSE by 2.9 dB for WTRU Cluster #1, 2.2 dB for WTRU Cluster #2, 2.5 dB for WTRU Cluster #3, 2.3 dB for WTRU Cluster #4, and/or 2.0 dB for WTRU Cluster #5. Thus, it implies that the AI/ML-based channel estimator trained with OTA-FL may generalize sufficiently well for different channel conditions by means of collaborative learning. Hence, when the channel conditions of a WTRU change (e.g., the WTRU moves from WTRU Cluster #1 to WTRU Cluster #5, and/or the WTRU velocity varies), OTA-FL may enable the WTRU to continue using the same AI/ML-based channel estimator.

1. A wireless transmit/receive unit (WTRU) comprising:
a processor configured to:
receive configuration information from a network for participating in one or more over-the-air federated learning (OTA-FL) training rounds of an Artificial Intelligence/Machine Learning (AI/ML) model residing at the WTRU, wherein the configuration information comprises an allocation of over-the-air reference signal (OTA-RS) resources and a mechanism to perform the uplink pre-equalization;
receive an indication of uplink resource allocations for transmitting pre-equalized locally updated AI/ML model parameters during the OTA-FL training rounds;
determine a trained AI/ML model through performing local AI/ML model training;
generate one or more of local AI/ML model parameters or gradients for a federated learning task;
perform channel estimation during the OTA-FL training rounds using OTA-RSs received via the OTA-RS resources;
determine uplink pre-equalization parameters based on the channel estimation;
pre-equalize the locally updated AI/ML model parameters for transmission on resource elements based on the uplink resource allocations and the pre-equalization parameters;
send the pre-equalized locally updated AI/ML model parameters during the OTA-FL training rounds over the uplink resources allocated according to the configuration information; and
receive an updated global AI/ML model.

2. The WTRU of claim 1, wherein the configuration information comprises mapping instructions that associate the pre-equalized locally updated AI/ML model parameters with uplink resource elements during the OTA-FL training rounds;
wherein the processor is configured to:
receive a configuration indicating how one or more of the locally updated AI/ML model parameters, gradients, or AI/ML parameter incremental updates are mapped to the uplink resources; or
receive a configuration indicating how the pre-equalized locally updated AI/ML model parameters are mapped as real and imaginary components of complex symbols for uplink transmission during the OTA-FL training rounds.

3. The WTRU of claim 1, wherein the processor is configured to transmit incremental updates to the AI/ML model parameters during the OTA-FL training rounds, the incremental updates representing differences between the locally updated AI/ML model parameters and parameters of a reference AI/ML model.

4. The WTRU of claim 1, wherein the processor is configured to perform channel estimation using the OTA-RSs, wherein the OTA-RSs comprise pilot sequences configured to provide a density higher than Channel State Information Reference Signals (CSI-RSs) in a frequency domain based on delay spread and a density higher than the CSI-RSs in a time domain based on a speed of the WTRU.

5. The WTRU of claim 1, wherein the processor is configured to receive calibration information from the network during the training rounds, wherein the calibration information indicates parameters to adjust uplink phase and amplitude errors associated with one or more resource elements (REs) during the OTA-FL training rounds.

6. The WTRU of claim 1, wherein the processor is configured to receive a calibration message from the network, wherein the calibration message indicates one or more WTRUs determined to be qualified for uplink transmission during the OTA-FL training rounds.

7. The WTRU of claim 1, wherein the uplink resources are allocated to a plurality of WTRUs performing a same OTA-FL task to transmit the pre-equalized locally updated AI/ML model parameters to the network.

8. The WTRU of claim 7, wherein the processor is configured to:
receive the indication of uplink resources for OTA-FL model parameter exchange dynamically via uplink scheduling grants with a group Radio Network Temporary Identifier (RNTI), wherein the group RNTI is common for the plurality of WTRUs performing the same OTA-FL task.

9. The WTRU of claim 1, wherein:
the uplink resources are dynamically allocated by at least one of downlink control information (DCI) or physical downlink control channel (PDCCH) transmission; and
the mechanism to perform the uplink pre-equalization comprises one or more of phase correction, channel inversion, or truncated channel inversion.

10. The WTRU of claim 1, wherein the processor is configured to refine the updated global AI/ML model received by the WTRU through multiple OTA-FL training rounds coordinated by the network.

11. A method implemented by a wireless transmit/receive unit (WTRU), the method comprising:
receiving configuration information from a network for participating in one or more over-the-air federated learning (OTA-FL) training rounds of an Artificial Intelligence/Machine Learning (AI/ML) model residing at the WTRU, wherein the configuration information comprises an allocation of over-the-air reference signal (OTA-RS) resources and a mechanism to perform the uplink pre-equalization;
receiving an indication of uplink resource allocations for transmitting pre-equalized locally updated AI/ML model parameters during the OTA-FL training rounds;
determining a trained AI/ML model by performing local AI/ML model training;
generating one or more of local AI/ML model parameters or gradients for a federated learning task;
performing channel estimation during the OTA-FL training rounds using OTA-RSs received via the OTA-RS resources;
determining uplink pre-equalization parameters based on the channel estimation;
pre-equalizing the locally updated AI/ML model parameters for transmission on resource elements based on the uplink resource allocations and the pre-equalization parameters;
sending the pre-equalized locally updated AI/ML model parameters during the OTA-FL training rounds over the uplink resources allocated according to the configuration information; and
receiving an updated global AI/ML model.

12. The method of claim 11, wherein the configuration information comprises mapping instructions that associate the pre-equalized locally updated AI/ML model parameters with uplink resource elements during the OTA-FL training rounds; and wherein the method further comprises:
receiving a configuration indicating how one or more of the locally updated AI/ML model parameters, gradients, or AI/ML parameter incremental updates are mapped to the uplink resources; or
receiving a configuration indicating how the pre-equalized locally updated AI/ML model parameters are mapped as real and imaginary components of complex symbols for uplink transmission during the OTA-FL training rounds.

13. The method of claim 11, further comprising transmitting incremental updates to the AI/ML model parameters during the OTA-FL training rounds, the incremental updates representing differences between the locally updated AI/ML model parameters and parameters of a reference AI/ML model.

14. The method of claim 11, further comprising performing channel estimation using the OTA-RSs, wherein the OTA-RSs comprise pilot sequences configured to provide a density higher than Channel State Information Reference Signals (CSI-RSs) in a frequency domain based on delay spread and a density higher than the CSI-RSs in a time domain based on a speed of the WTRU.

15. The method of claim 11, further comprising receiving calibration information from the network during the training rounds, wherein the calibration information indicates parameters to adjust uplink phase and amplitude errors associated with one or more resource elements (REs) during the OTA-FL training rounds.

16. The method of claim 11, further comprising receiving a calibration message from the network, wherein the calibration message indicates one or more WTRUs determined to be qualified for uplink transmission during the OTA-FL training rounds.

17. The method of claim 11, wherein the uplink resources are allocated to a plurality of WTRUs performing a same OTA-FL task to transmit the pre-equalized locally updated AI/ML model parameters to the network.

18. The method of claim 17, further comprising:
receiving the indication of uplink resources for OTA-FL model parameter exchange dynamically via uplink scheduling grants with a group Radio Network Temporary Identifier (RNTI), wherein the group RNTI is common for the plurality of WTRUs performing the same OTA-FL task.

19. The method of claim 11, wherein:
the uplink resources are dynamically allocated by at least one of downlink control information (DCI) or physical downlink control channel (PDCCH) transmission; and
the mechanism to perform the uplink pre-equalization comprises one or more of phase correction, channel inversion, or truncated channel inversion.

20. The method of claim 11, further comprising refining the updated global AI/ML model received by the WTRU through multiple OTA-FL training rounds coordinated by the network.
